(19) United States
(12) Patent Application Publication
(10) Pub. No.: US 2022/0088960 A1
(43) Pub. Date: Mar. 24, 2022

(54) PROCEDURE FOR TILE DECORATION

(71) Applicant: Graf S.p.A., Nonantola (MO) (IT)

(72) Inventors: Andrea VACCARI, Nonantola (IT); Denis DE GRANDIS, Nonantola (IT)

(73) Assignee: Graf S.p.A., Nonantola (MO) (IT)

(21) Appl. No.: 17/427,927

(22) PCT Filed: Feb. 10, 2020
(86) PCT No.: PCT/IB2020/051007

§ 371 Date: Aug. 3, 2021

(30) Foreign Application Priority Data
Feb. 11, 2019 (IT) 102019000001911

(51) Int. Cl. B44C 5/04; B28B 11/00; B28B 11/06; B28B 11/24

(52) U.S. Cl. CPC B44C 5/04; B28B 11/243; B28B 11/06; B28B 11/001

(57) ABSTRACT

The procedure for tile (1) decoration comprises the following phases:
providing a ceramic article (2) in raw material, provided with a flat surface to be decorated (3);
depositing thoroughly a decorative powder (4) on the flat surface to be decorated (3);
fixing the decorative powder (4) to the flat surface to be decorated (3) by means of radiation-emitting fixing means (5), according to a predefined drawing (6);
removing the decorative powder (4) in excess to obtain a decorated ceramic article (7);
firing the decorated ceramic article (7) in a kiln to obtain a tile (1).

### TECHNICAL FIELD

The present invention relates to a procedure for tile decoration.

### BACKGROUND ART

The decoration of tiles consists in the application of decorative elements on the surface of flat articles, made of raw ceramic material or partially fired at reduced temperatures, to be then completely and definitively stabilized by firing at high temperatures.

Generally, the procedures for the decoration of tiles of known type involve the use of nano inks deposited on the surface of the articles by means of special digital printers with piezoelectric heads.

More in detail, nano inks are mixtures of powder dyes in very fine grain size, suspended in a special solvent or other carrier.

This procedure for the decoration of tiles has some drawbacks related to the use of the aforementioned nano inks.

In particular, the grinding of dyes for nano inks is carried out by means of special equipment (atomizers and/or turbines) which are able to reduce the particles to a very small size, in the order of microns, but which are very expensive and have a rather low production output, as well as not negligible energy consumption.

As a result, the overall costs for the production of nano inks are particularly high and are reflected in the final price of the tiles, with the risk of making the products less attractive to customers.

At the same time, the solvents required for the production of nano inks are usually organic solvents, which are harmful to the environment and the health of the operators using them, but also cause the printing heads to wear out quickly. Moreover, the procedures of known type do not allow obtaining a surface decoration of the material type, i.e. presenting reliefs and hollows that faithfully reproduce the three-dimensional structured surfaces such as those of wood, rocks, stones or the like.

U.S. Pat. No. 5,422,146 A describes a procedure for the decoration of articles, including ceramic articles, which is free from the use of inks and makes use of coloured powders.

In particular, U.S. Pat. No. 5,422,146 A teaches how to use radiation-emitting fixing means, wherein the radiation source must cause the coloured powder to be completely fixed, so that subsequent firing in the kiln is not necessary and the decorated article does not have to be unnecessarily subjected to high temperatures.

However, in order to achieve the complete stabilization mentioned above, the radiation source must be characterized by a high power, allowing the complete interaction between the pigments of the coloured powder and the article.

Consequently, this decoration procedure also requires the use of expensive and energy-intensive equipment which leads to an increase in the cost of the final product.

Moreover, by means of this procedure, the surface of the obtained article is less resistant to wear than an article in which the deposited powder has undergone a process of heating at high temperatures, through which the pigments blend with the entire article.

Furthermore, not even the procedure described by U.S. Pat. No. 5,422,146 A allows obtaining a surface decoration of the material type.

In the light of the aforementioned considerations, it is clear that the known decoration procedures above are subject to further upgrading aimed at obtaining decorated ceramic articles with a valuable aesthetic effect, in a practical, safe and economical way.

### DESCRIPTION OF THE INVENTION

The main aim of the present invention is to devise a procedure for tile decoration that allows creating ceramic articles of valuable aesthetic effect through a chromatic and/or material type surface decoration.

A further object of the present invention is to devise a procedure for tile decoration that allows getting rid of the use of nano inks and digital printers. Another object of the present invention is to devise a procedure for tile decoration that allows using low cost decorative equipment and materials in order to obtain decorated tiles, in a practical and safe way for the environment and operators.

Another object of the present invention is to devise a procedure for tile decoration that allows overcoming the aforementioned drawbacks of the prior art in the ambit of a simple, rational, easy, effective to use and low cost solution. The objects set out above are achieved by the present procedure for tile decoration having the characteristics of claim 1.

### BRIEF DESCRIPTION OF THE DRAWINGS

Other characteristics and advantages of the present invention will be more evident from the description of a preferred, but not exclusive, embodiment of a procedure for tile decoration, illustrated as an indication, but not limited to, in the attached tables of drawings in which:

FIG. 1 is an axonometric view of the procedure according to the invention as a whole;

FIGS. 2-8 are axonometric and/or lateral views that illustrate the various phases of the procedure according to the invention.

### EMBODIMENTS OF THE INVENTION

With particular reference to these figures, reference numeral 1 globally indicates a tile which is obtained by means of the procedure according to the invention. For the purposes of the present treatise, it should be noted that the word “tile” means a slab-shaped article with width and length significantly bigger than its thickness, i.e. at least one order of magnitude bigger (i.e. more than 10 times bigger).

The procedure shall comprise at least the following phases:
providing at least one ceramic article 2 in raw material, provided with at least one flat surface to be decorated 3;
depositing thoroughly at least one decorative powder 4 on the flat surface to be decorated 3;
fixing the decorative powder 4 to the flat surface to be decorated 3 by means of radiation-emitting fixing means 5, according to a predefined drawing 6;
removing the decorative powder 4 in excess to obtain a decorated ceramic article 7;
firing the decorated ceramic article 7 in a kiln to obtain a tile 1.

The ceramic article 2 to which the present procedure relates, is made of raw material and has a substantially flat surface.

For the purposes of the present treatise, the words “raw material” mean a mixture of ceramic material that has not yet undergone kiln firing; the words “substantially flat surface” also mean slightly convex surfaces or surfaces that have been suitably processed in order to give a particular aesthetic effect to the final tile (so-called “structured surfaces”).

Advantageously, the above mentioned phases are carried out continuously on a feeding forward line 8 which extends along a sliding direction D, on which the ceramic article 2 is placed with the flat surface to be decorated 3 facing upwards.

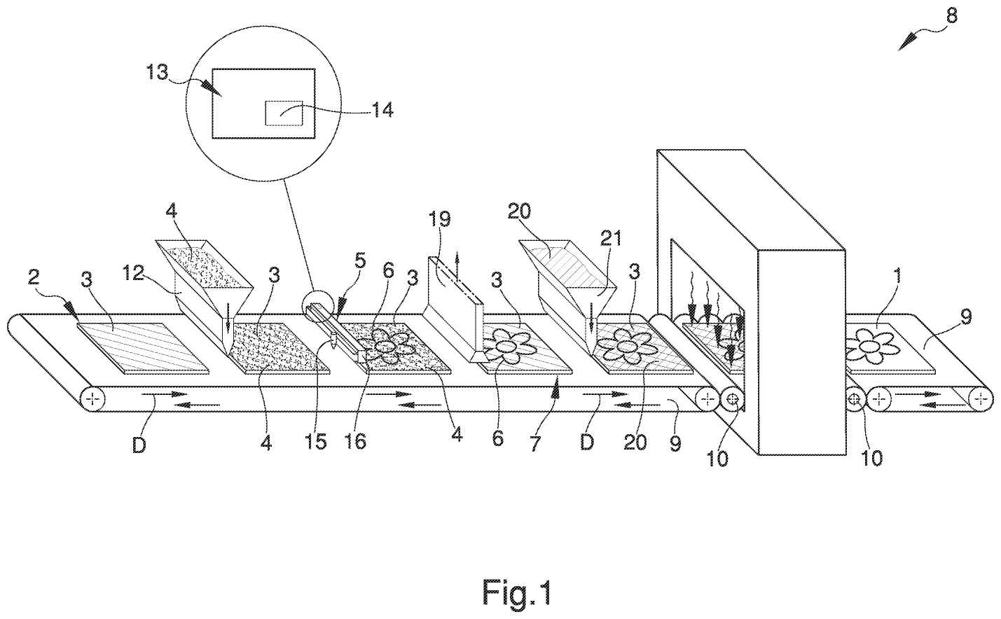

In the embodiment shown in FIG. 1, the feeding forward line 8 is schematically represented in the form of a series of conveyor belts 9 and roller conveyors 10 positioned in succession, on which the different phases of the procedure are carried out according to the invention.

It is easy to understand, however, that alternative embodiments are possible in which the feeding forward line 8 consists of feeding forward systems different from those illustrated and intended, e.g., to transfer the ceramic article 2 between different processing stations intended to put into practice the phases of the procedure according to the invention.

Conveniently, the decorative powder 4 used in the present procedure comprises powdered compounds 11.

The powdered compounds 11 are selected from the list comprising: ceramic pigments, sands and clays (e.g. kaolin and bauxite), glass fragments, quartz, or other compounds which are adapted to give a particular decorative effect.

In the present discussion, the words “ceramic pigments” mean colouring substances used in the ceramic industry to colour the ceramic articles and consist of mineral oxides, or metal oxides, or metals characterized by complex structures.

It should be noted that the decorative powder 4 can be made with a variety of different powdered compounds and variable grain sizes, from the finest powder to flakes.

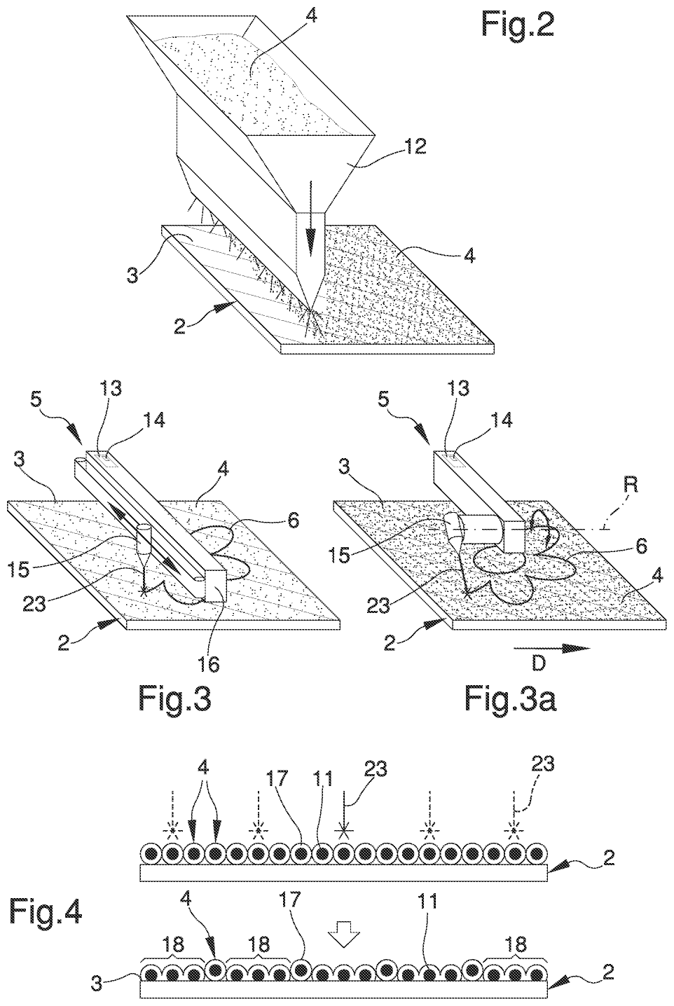

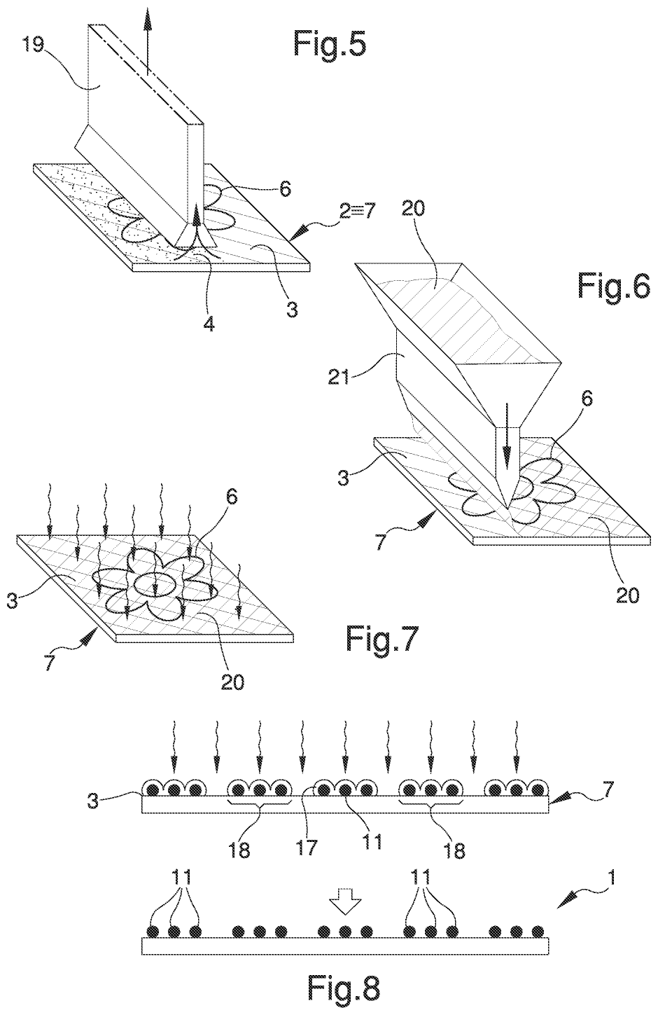

As shown in FIGS. 1 and 2, the phase of thoroughly depositing the decorative powder 4 can be advantageously obtained by falling from a distributor 12 (e.g. a hopper), placed on top of the feeding forward line 8.

In order to ensure uniform application on the flat surface to be decorated 3, the decorative powder 4 can be distributed by electrostatic deposition.

Through this methodology, the particles of decorative powder 4 are subjected to a negative or positive electric charge, while the ceramic article 2 is grounded (potential 0).

This way, the decorative powder 4 is attracted by the flat surface to be decorated 3 thus ensuring uniform coverage.

Subsequently, the ceramic article 2 continues towards the fixing means 5, by means of which the decorative powder 4 is fixed according to the predefined drawing 6.

Conveniently, the fixing means 5 comprise at least one electronic unit 13 comprising at least one storage unit 14 adapted to store the predefined drawing 6.

Advantageously, the fixing means 5 comprise at least one laser device 15, electronically connected to the electronic unit 13, able to radiate particular points of the above mentioned flat surface to be decorated 3, fixing only predefined portions of the decorative powder 4 corresponding to the predefined drawing 6.

Advantageously, the laser device 15 can emit radiation with a punctiform-section beam 23, and is positioned so that this beam 23 of radiation is substantially transverse to the flat surface to be decorated 3.

In particular, in the embodiment shown in FIGS. 1 and 3, the beam 23 is substantially perpendicular to the flat surface to be decorated 3 and the fixing phase comprises the travel of aforementioned beam 23 along a direction substantially parallel to the flat surface to be decorated 3 and transverse to the sliding direction D.

In this embodiment, the laser device 15 is mounted on a crossbar 16 which is arranged on top of the feeding forward line 8 and which extends along a horizontal direction and orthogonal to the sliding direction D.

The laser device 15 slides on the crossbar 16 so that it can move from one side to the other of the ceramic article 2 across its entire width and direct the radiations to any point on the ceramic article 2 as it moves forward along the sliding direction D.

In other words, the laser device 15 behaves in the same way as a head for printers and can be moved at the same time as the ceramic article 2 slides.

In a further embodiment, not shown in detail in the figures, the beam 23 can travel by means of special reflective means that can be moved with respect to the crossbar 16.

In this embodiment, the laser device 15 is fixed with respect to the crossbar 16, while the movement of the beam 23 is carried out through the reflective means, sliding on the crossbar 16.

In a further embodiment, shown in FIG. 3a, the fixing phase comprises rotating the beam 23 around an axis of rotation R substantially non-orthogonal to the sliding direction D.

In particular, the axis of rotation R is parallel to the sliding direction D and allows the rotation of the beam 23 in a plane substantially perpendicular to the flat surface to be decorated 3, so as to radiate any point of the ceramic article 2 as it moves forward along the sliding direction D.

It should be noted that during the fixing phase, the beam 23 is able to hit every point of the flat surface to be decorated 3 according to the predefined drawing 6. At the points where the radiation beam 23 hits the decorative powder 4, an interaction is induced between the flat surface to be decorated 3 and the powdered compounds 11, which ensures the fixing thereof on the flat surface to be decorated itself.

In particular, the beam 23 is able to induce a chemical interaction between the ceramic pigments that make up the decorative powder 4 and the ceramic material of the ceramic article 2.

In this respect, it should be noted that, in order to facilitate the fixing of the particles of decorative powder 4 to the flat surface to be decorated 3, the present procedure may, if necessary, envisage the solution schematically shown in FIG. 4, wherein the decorative powder 4 comprises at least one coating element 17 which covers the powdered compounds 11 and which is made of a binding material.

The binding material is a material that has adhesive properties when activated by radiation emitted by the fixing means 5.

For example, the binding material is a thermo-adhesive material which, when not hit by the beam 23, has no and/or negligible adhesive properties, thus allowing the particles of decorative powder 4 not to stick together and/or to the flat surface to be decorated 3, while, when hit by the beam 23, it heats up, melts at least partially and becomes adhesive.

The fixing of the decorative powder 4 occurs mainly by adhesion of the coating element 17 to the flat surface to be decorated 3 and/or to another adjacent coating element 17.

In particular, the beam 23 of emitted radiation, by hitting the decorative powder 4, induces the binding material of which the coating element 17 is made of, to exhibit adhesive properties and to join the flat surface to be decorated 3 and/or the adjacent coating elements 17.

Obviously, only the portions 18 of decorative powder 4 hit by the radiation beam 23 fix to the ceramic article 2.

The binding material can be suitably made of a polymeric material and, since most polymeric materials can be melted and/or softened even at relatively low temperatures, the special solution of coating the powdered compounds 11 with the coating element 17 made of polymeric material makes it possible in actual facts to use low power laser devices 15, with a consequent reduction in the costs associated with the use of this technology.

Once the fixing phase is finished, the ceramic article 2 undergoes the next phase in which the decorative powder 4 in excess, i.e. the one not fixed according to the predefined drawing 6 during the previous phase, is removed in order to obtain the decorated ceramic article 7.

Advantageously, removal can occur by suction and/or blowing, and can allow the recovery of the unfixed decorative powder 4 for later use.

In the embodiment shown in FIGS. 1 and 4, e.g., the removal phase of the decorative powder 4 in excess occurs by means of a vacuum cleaner 19 placed on top of the feeding forward line 8.

The vacuum cleaner 19 extends over the entire width of the ceramic article 2 so as to pass over the entire flat surface to be decorated 3 as the ceramic article 2 moves forward along the sliding direction D.

Afterwards, at least one protective coating 20 may possibly be applied to the decorated ceramic article 7 before firing.

The protective coating 20 is intended to provide greater resistance to decoration and to give a special finish to the tile 1.

The protective coating 20 may be, e.g., a glossy or matt glaze, which is fixed in turn during firing, or it may consist of glass flakes which, after treatment at high temperatures, melt to form a protective layer.

In the embodiment shown in FIGS. 1 and 6, for example, the application phase of the protective coating 20 can be advantageously obtained by means of an applicator 21 placed on top of the feeding forward line 8, which distributes the protective coating 20 as the decorated ceramic article 7 moves forward along the sliding direction D.

Finally, the decorated ceramic article 7 is fired inside a kiln 22 at high temperatures (over 1100° C.), thus obtaining the tile 1.

This phase has both the function of transforming the raw material mixture, providing the tile 1 with a mechanically resistant structure, and the function of stabilizing the decoration on the tile 1.

At the firing temperature of the ceramic material, the decorative powder 4 is completely fixed to the flat surface to be decorated 3.

As shown in FIG. 8, when the powdered compounds 11 are covered by the coating element 17, the heat hitting the decorated ceramic article 7 inside the kiln 22 leads to an initial sublimation of the coating element 17 and then to the stabilization of the powdered compounds 11 on the tile 1.

It is important to underline that the complete fixing of the powdered compounds 11 is ensured by the high temperatures that are reached during the firing phase; therefore, the fixing of the decorative powder 4 by means of radiation emission can take place by means of low power laser devices 15.

The procedure for tile 1 decoration can also comprise the repetition of the phases of depositing, fixing and removing with different decorative powders 4 and/or with different predefined drawings 6, before carrying out the possible phase of application of the protective coating 20 and the necessary final firing phase in the kiln 22.

The present procedure allows, for example, to make the desired decoration using only decorative powders 4 having a limited number of primary colours, repeating the phases of depositing, fixing and removing with a first primary colour, with a second primary colour, with a third primary colour and so on.

This way, at each repetition the decorative powders 4 can be fixed one on top of the other in order to combine and generate colours which are different to the primary colours.

In addition, the electronic unit 13 can determine an appropriate movement of the beam 23, following several predefined drawings 6 set on the storage unit 14 depending on the type of decorative powder 4 used.

In other words, the fixing phase of the decorative powder 4 having the first primary colour can be carried out following a first pre-established drawing, the fixing phase of the decorative powder 4 having the second primary colour can be carried out following a second pre-established drawing, the fixing phase of the decorative powder 4 having the third primary colour can be carried out following a third pre-established drawing, and so on.

Again, the procedure for tile 1 decoration can comprise the repetition of the phases of depositing, fixing and removing to make a plurality of overlapping layers of decorative powder 4 to obtain a material effect.

More in detail, the repetition of the phases mentioned above allows making protrusions and hollows on the flat surface to be decorated 3 in order to reproduce the aesthetic effect of structured three-dimensional surfaces such as those made of wood, rocks and natural stones, or the like.

The execution of the removal phase, at each repetition cycle of the phases, allows the reuse of the different decorative powders 4 for subsequent processing.

The operation of the invention as shown in FIG. 1 is as follows.

The ceramic article 2, made of raw material, is positioned on the feeding forward line 8 and moved forward along the sliding direction D.

By transiting below the distributor 12, the flat surface to be decorated 3 is thoroughly covered with the decorative powder 4.

The decorative powder 4 is then fixed according to the predefined drawing 6 by the fixing means 5 and the excess is then removed by suction using the vacuum cleaner 19.

The protective coating 20 is then applied to the flat surface to be decorated 3 and the decorated ceramic article 7 continues along the sliding direction D for firing inside the kiln 22.

The decorated tile 1 is obtained at the exit of the kiln 22.

It has in practice been ascertained that the described invention achieves the intended objects and in particular it is underlined that the present procedure for tile decoration makes it possible to create ceramic articles with a valuable aesthetic effect through a chromatic and/or material-like surface decoration using decorative powders made up of ceramic pigments, sands and clays, and other decorative materials.

In addition, the present procedure allows getting rid of the use of nano inks and digital printers, with a consequent reduction in the costs linked to this technology and a lower environmental impact.

The decorative powders, in fact, in addition to being safer for the operators' health and the environment, are used in the phases prior to the firing of the ceramic material, with a consequent reduction in the costs linked to the use of high power laser devices.

Furthermore, the special solution of providing for an electrostatic deposition of the decorative powder allows homogeneous distribution of the latter even in the presence of reliefs or particular aesthetic effects on the ceramic article.

In conclusion, the procedure for tile decoration makes it possible to obtain decorated tiles, using low cost equipment in a practical, safe and economical way.

1) Procedure for tile (1) decoration, wherein said procedure comprises at least the following phases:
providing at least one ceramic article (2) in raw material, provided with at least one flat surface to be decorated (3);
depositing thoroughly at least one decorative powder (4) on said flat surface to be decorated (3);
fixing said decorative powder (4) to said flat surface to be decorated (3) by means of radiation-emitting fixing means (5), according to a predefined drawing (6);
removing said decorative powder (4) in excess to obtain a decorated ceramic article (7);
firing said decorated ceramic article (7) in a kiln to obtain a tile (1).

2) Procedure for tile (1) decoration according to claim 1, wherein said phases are carried out continuously on a feeding forward line (8) which extends along a sliding direction (D).

3) Procedure for tile (1) decoration according to claim 1, wherein said procedure comprises the repetition of said phases of depositing, fixing and removing with different decorative powders (4) and/or different predefined drawings (6).

4) Procedure for tile (1) decoration according to claim 1, wherein said procedure comprises the repetition of said phases of depositing, fixing and removing to make overlapping layers of decorative powder (4) to obtain a material effect.

5) Procedure for tile (1) decoration according to claim 1, wherein said decorative powder (4) comprises powdered compounds (11).

6) Procedure for tile (1) decoration according to claim 5, wherein said powdered compounds (11) are selected from the list comprising: ceramic pigments, sands and clays, glass, quartz, or a combination thereof.

7) Procedure for tile (1) decoration according to claim 1, wherein said depositing takes place by electrostatic deposition of said decorative powder (4) on said flat surface to be decorated (3).

8) Procedure for tile (1) decoration according to claim 1, wherein said fixing means (5) comprise at least one electronic unit (13) comprising at least one storage unit (14) adapted to store said predefined drawing (6).

9) Procedure for tile (1) decoration according to claim 8, wherein said fixing means (5) comprise at least one laser device (15), electronically connected to said electronic unit (13).

10) Procedure for tile (1) decoration according to claim 9, wherein said laser device (15) emits said radiations with punctiform-section beam (23).

11) Procedure for tile (1) decoration according to claim 10, wherein said beam (23) is substantially transversal with respect to said flat surface to be decorated (3).

12) Procedure for tile (1) decoration according to claim 11, wherein said beam (23) is substantially perpendicular with respect to said flat surface to be decorated (3).

13) Procedure for tile (1) decoration according to claim 10, wherein said fixing comprises translating said beam (23) along a direction substantially parallel to said flat surface to be decorated (3) and transversal with respect to said sliding direction (D).

14) Procedure for tile (1) decoration according to claim 10, wherein said fixing comprises rotating said beam (23) around an axis of rotation (R) substantially non-orthogonal to said sliding direction (D).

15) Procedure for tile (1) decoration according to claim 1, wherein said fixing takes place by interaction between said decorative powder (4) and said flat surface to be decorated (3) as a result of the emission of said radiations by said fixing means (5).

16) Procedure for tile (1) decoration according to claim 5, wherein said decorative powder (4) comprises at least one coating element (17) which covers said powdered compounds (11) and which is made of a binding material.

17) Procedure for tile (1) decoration according to claim 16, wherein said fixing takes place by adhesion of said coating element (17) to said flat surface to be decorated (3) and/or to another adjacent coating element (17), said coating element (17) being at least partially melted after the emission of said radiations by said fixing means (5).

18) Procedure for tile (1) decoration according to claim 16, wherein said firing phase comprises the sublimation of said coating element (17).

19) Procedure for tile (1) decoration according to claim 1, wherein said removing takes place by suction and/or blowing.

20) Procedure for tile (1) decoration according to claim 1, wherein said procedure comprises applying at least one protective coating (20) to said decorated ceramic article (7).
